(19) United States
(12) Patent Application Publication
(10) Pub. No.: US 2004/0266328 A1
(43) Pub. Date: Dec. 30, 2004

(54) Food processing method and apparatus

(76) Inventors: John B. Hinkey, Seattle, WA (US); Gerald R. Berg, Renton, WA (US); Donn C. Mueller, Allston, MA (US); Kirk R. Lupkes, Renton, WA (US); Michael J. Aarnio, Kirkland, WA (US)

Correspondence Address: BACHMAN & LAPOINTE, P.C., 900 CHAPEL STREET, SUITE 1201, NEW HAVEN, CT, 06510, US

(21) Appl. No.: 10/431,281

(22) Filed: May 7, 2003

(51) Int. Cl. A22C 9/00

(52) U.S. Cl. 452/141

(57) ABSTRACT

A food processing apparatus has fuel and oxidizer sources and an igniter positioned to ignite a mixture of fuel and oxidizer. The ignition produces a shock wave. The igniter is positioned to sequentially ignite sequential mixtures to produce sequential shock waves. A conveyor carries items of food to an operative position to be impacted by shock waves.

### BACKGROUND OF THE INVENTION

(1) Field of the Invention

This invention relates to food processing, and more particularly to use of relative pressure to tenderize meat.

(2) Description of the Related Art

The use of shock waves for meat tenderization is known. Exemplary systems are shown in U.S. Pat. Nos. 6,206,773, 6,264,543, and 6,306,029 as well as Japanese patent publication 05-336875. In U.S. patent application publication 2002/0009526, a tenderization system involving a rapid decompression is identified. Such a decompression effect may be similar to the decompression associated with the passing of a shock wave and is believed to tenderize the meat by straining and rupturing some of the microscopic fibers forming the meat.

### BRIEF SUMMARY OF THE INVENTION

One aspect of the invention involves a food processing apparatus having fuel and oxidizer sources. An igniter is positioned to sequentially ignite sequential mixtures of fuel and oxidizer to produce shock waves. A conveyor carries items of food to an operative position to be impacted by the shock waves.

In various implementations, the items of food are carried by the conveyor through a vessel. In an operative position in the vessel, the items of food are immersed in an aqueous liquid for the shock wave impact. A second igniter may be positioned to sequentially ignite fuel and oxidizer to produce sequential second shock waves. The conveyor may carry the items of food through a second operative position in which the items of food are immersed in the liquid for impact of the second shock waves. The apparatus may have a combustor tube positioned to direct the shock waves through air between the tube and an item of the food in an operative position in front of the tube. The fuel may consist essentially of hydrogen and the oxidizer may consist essentially of oxygen.

Another aspect of the invention involves an apparatus for processing food. A vessel contains the food. Means are provided for decompressing the food.

Another aspect of the invention involves a method for processing food. Fuel and an oxidizer are mixed and detonated to produce a shock wave. The shock wave is impinged upon the food.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a schematic view of a first food processing system.

FIG. 2 is a schematic view of a second food processing system.

FIG. 3 is a schematic view of a third food processing system.

FIG. 4 is a schematic view of a fourth food processing system.

FIG. 5 is a schematic view of a fifth food processing system.

FIG. 6 is a schematic view of a sixth food processing system.

FIG. 7 is a schematic view of a seventh food processing system.

FIG. 8 is a schematic view of an eighth food processing system.

Like reference numbers and designations in the various drawings indicate like elements.

### DETAILED DESCRIPTION

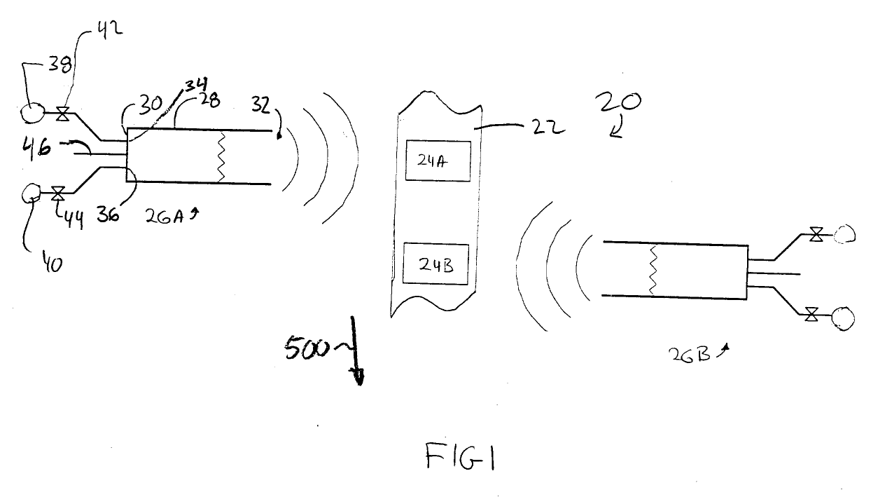

FIG. 1 shows a meat tenderization system 20 including a conveyor 22 carrying items of food (pieces of meat 24A and 24B) in a downstream direction 500 along a meat flow path. Along the flow path, the meat may occupy operative positions in front of one or more shock wave generators 26A and 26B. Although in the exemplary embodiment there is a single piece of meat in a single operative position for each generator and the operative positions are not coincident, this construction should not be regarded as limiting.

Each generator includes a detonation combustor tube 28 having a closed proximal end or breech 30 and an open distal end or muzzle 32. The breech has ports 34 and 36 for respectively receiving fuel and oxidizer from fuel and oxidizer supplies or sources 38 and 40. These sources may be shared by more than one generator. The fuel and oxidizer mix upon introduction to the breech. Alternatively, the fuel and oxidizer may be mixed before reaching the breech. Valves 42 and 44 may selectively control flow of fuel and oxidizer from their respective sources through respective supply lines.

The generator further includes means for igniting the fuel/oxidizer mixture. This may include a spark source 46 mounted in the breech as an igniter. In an exemplary embodiment, the space between the muzzle and piece of meat in the associated operative position is substantially occupied by air at ambient conditions. When the spark source is triggered, it causes the ultimate detonation of the fuel/oxidizer mixture generating a shock wave within the combustor tube. The shock wave propagates from the muzzle to impinge upon the exposed surface of the meat and penetrate the meat. The use of multiple generators may provide a cumulative effect and may serve to expose different surface portions of the meat to shock waves.

An exemplary fuel/oxidizer combination is ethylene, ethane, propane, other hydrocarbon, or hydrogen as fuel and air or oxygen as oxidizer. An exemplary igniter is a spark plug. An exemplary conveyor is a belted or linked support conveyor. Hanging or other conveyors may alternatively be used. The system may be operated so that each piece of meat is subjected to multiple shock waves from each generator. For example, each generator may be operated to sequentially combust fuel/air charges at an exemplary frequency of between one and ten charges per second. Each piece of meat may be exposed to an exemplary 1-100 shocks from each generator, or typical minimum number of shocks would be five or ten and a typical maximum would be twenty.

Beyond tenderization, the system may be alternatively or simultaneously used to achieve other goals. These may include sterilization to kill inherent microorganisms or contaminants. Sterilization may be particularly relevant to non-meat products, including vegetable products and processed food combinations.

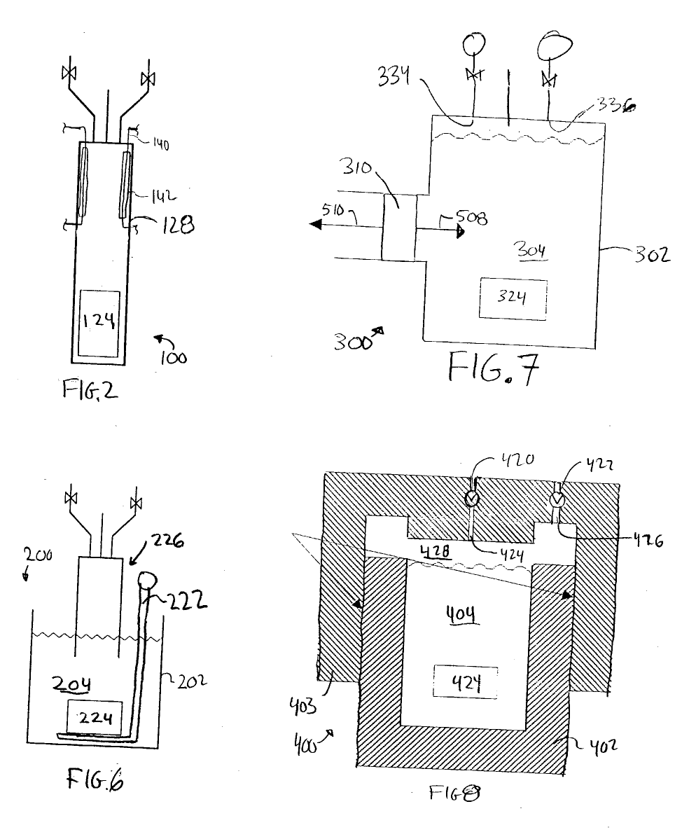

FIG. 2 shows an alternate system 100 in which the combustor tube 128 contains the meat 124. Initially, the meat is within a distal volume of the tube containing air. The fuel and oxidizer (or pre-mixed mixture thereof) are introduced into a proximal volume of the tube to form a mixture. Optionally, a diaphragm (not shown) may separate the distal volume from the proximal volume. Upon detonation of the fuel/oxidizer mixture, the resulting shock wave ruptures the diaphragm (if present) and impinges upon the meat. Thereafter, it may be desirable to cool the combustion product so as to reduce the temperature and pressure within the tube. For example, heat transfer tubes 140 may carry a refrigerant, water, or other coolant and may have heat transfer fins 142 or other surface area enhancements in contact with the combustion gases. The meat may then be removed through an appropriate closure (not shown) of the tube.

When the spark source is triggered, it may typically initiate a laminar flame front within the fuel/oxidizer mixture. The laminar flame front transitions into a turbulent flame front. Given a long enough combustor the turbulent flame would naturally transition into a detonation through the deflagration to detonation transition (DDT) process. It may be desirable to include means for expediting the DDT to reduce the DDT distance. This may be achieved through the use of orifice plates, Shchelkin spirals, or a number of other devices. These devices produce transverse pressure waves within the combustor which enhance the DDT process. These devices have proven effective in both fuel/air and fuel/oxygen mixtures. Another method for producing a detonation in a given fuel/air mixture is to first initiate a detonation in a more detonable fuel/oxidizer mixture and let the detonation travel from the easily detonated mixture into the other. This process can also be enhanced by devices such as orifice plates or Shchelkin spirals. By way of example, FIGS. 3-5 show such features as applied to a closed tube. They may similarly be applied to open tubes. FIG. 3 shows an alternate system 150 having a number of orifice plates 152A-152D from upstream-to-downstream within the tube. The exemplary plates are formed as centrally-apertured disks having circular perimeters sealingly secured to the tube inner wall surface and coaxial circular apertures. The plates are spaced apart from each other between the spark source and meat and may have additional apertures accommodating cooling conduits (e.g., shown for the upstream three plates 152A-152C).

FIG. 4 shows an alternate system 175 with a Shchelkin spiral 176 positioned between the spark source and meat. The exemplary spiral has an outer periphery in sealing contact with the tube inner surface and has a central longitudinal passageway. Both the systems 150 and 175 have first (primary) and second (pilot) pairs of fuel and oxidizer conduits. For example: a first fuel conduit 162; a first oxidizer conduit 163; a second fuel conduit 164; and a second oxidizer conduit 165 (FIG. 3). The conduits 162 and 163 may introduce a primary fuel/oxidizer combination while the conduits 164 and 165 introduce a second such combination. In an exemplary embodiment, the primary combination is first introduced so as to substantially fill a desired portion of the tube whereupon the second combination is introduced to a space relatively close to the spark source. As discussed above, the spark source may induce detonation of the second, more detonable combination which, in turn, detonates the other. Exemplary combinations of primary mixtures and secondary (pilot) mixtures are: propane/air and acetylene/air; propane/air and ethylene/oxygen; and hydrogen/air and hydrogen/oxygen. Among other permutations are varying proportions of a given mixture to achieve a similar effect.

FIG. 5 shows a further accentuated staggering of the introduction locations of the primary and secondary fuel/air combinations. The exemplary system 180 features a tube having a relatively small diameter/cross-section proximal volume 181 into which the secondary (pilot) conduits 164 and 165 feed. The primary conduits 162 and 163 feed to a location proximate an interface (e.g., a shoulder 182) between the proximal volume 181 and the greater cross-sectional area main volume 183 distally (downstream) thereof. The introduction of primary and pilot mixtures may be roughly simultaneous, with the separation being achieved via the physical staggering and other tube geometry. Other variations include the staggering without the relatively small proximal volume and the relatively small proximal volume without the staggering. Where only one form of oxidizer and/or fuel is used, there may be no need for two separate conduits/sources for that component. A single conduit or conduit with a branch may be used for such component.

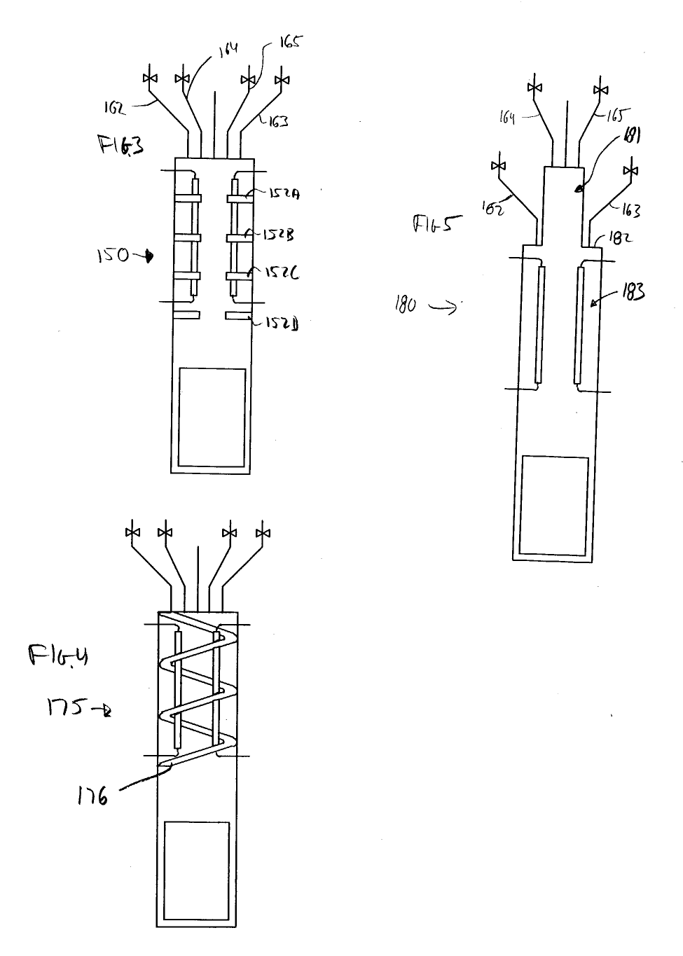

Additional alternate systems may direct the shock wave to the meat through a liquid rather than a gas. Relative to a gas, a liquid may achieve a closer acoustic impedance match with the meat. This match is desirable to allow efficient transfer of the shock wave from the surrounding fluid to the meat. Water (or, more generally, aqueous solutions or mixtures) has a good impedance match and may present negligible to minimal toxicity concerns. FIG. 6 shows one alternate system 200 including a vessel 202 containing water 204. A conveyor 222 carries pieces of meat 224 through an operative position within the vessel. The generator 226, which may be generally similar to the generators 26A and 26B, is positioned with its muzzle immersed in the water in facing proximity to the piece of meat in the operative position. Upon detonation, the shock wave propagates through the water to impinge upon the meat.

Similarly, the aforedescribed systems 100, 150, 175, and 180 could be utilized with water initially filling the distal volume. The shock wave would be directed through the water to impinge upon the meat. The same or similar device could be utilized to subject the meat to a rapid decompression to achieve a similar effect. For example, the system 100 may be utilized with water in the distal volume and a fuel/oxidizer combination that reacts to decrease pressure (e.g., a decrease in molar amount of gas in the proximal volume). One example is hydrogen and oxygen reacting to produce water. The hydrogen combustion may initially increase pressure in the vessel due to increased temperatures. However, the combustion gases may be cooled by the water in the vessel and by additional cooling such as the heat transfer tubes 140 (FIG. 2) having heat transfer fins 142 or other surface area enhancements in contact with the combustion gases. Upon such cooling, the depressurization may enhance the tenderizing effect.

FIG. 7 shows an alternate system 300 in which a vessel 302 contains water 304 in which the meat 324 is immersed. A piston 310 is coupled to the vessel. The vessel may be initially pressurized. For example, the piston may be inserted in a direction 508 to a specific first position or until a specific first pressure is reached. The piston may then be withdrawn in an opposite direction 510 to rapidly depressurize the vessel. The rate of pressurization and/or depressurization may be controlled by controlling the piston motion (e.g., velocity). Advantageously, the depressurization is more rapid than the pressurization (at least over substantial portions of the pressure range effective to provide the desired effect on the food). The depressurization from the pressurized pressure may be to a depressurized pressure at, above, or below the ambient starting pressure. For such apparatus, cooling means (not shown) may also be added but may have less utility than in combustion systems.

In a variation, the initial pressurization from ambient pressure to a first elevated pressure may result from the introduction of fuel and oxidizer or a premix such as through fuel and oxidizer ports 334 and 336. The piston insertion causes a second pressurization to a second pressure above the first. Ignition of the fuel/oxidizer mixture, may cause a further pressurization to a substantially elevated third pressure. Upon piston withdrawal and venting of the interior, the process may be repeated on the same item or a subsequent item.

FIG. 8 shows an alternate system 400 in which a first vessel portion 402 contains the water 404 and meat 424 and acts as a piston within a second vessel portion 403. The first vessel portion may be inserted into the second vessel portion to initially pressurize the water. The second portion may then be relatively withdrawn to depressurize the water and meat. Alternative to initial pressurization, one or more one-way check valves 420 and 422 in evacuation conduits 424 and 426 may, upon such insertion, evacuate the headspace 428 of air and some of the water. In yet other variations, the valves would be controllable so that, after the headspace evacuation, the valves could be closed during a final stage of insertion to permit initial pressurization. In yet other variations, various conduits could be provided to introduce water either within the vessel portion 402 or headspace 428 after vessel assembly.

One or more embodiments of the present invention have been described. Nevertheless, it will be understood that various modifications may be made without departing from the spirit and scope of the invention. For example, scale, manufacturability, and other engineering considerations may be relevant to the form of any actual implementation of the inventive apparatus and methods. The apparatus and methods may be combined with other features or processes to achieve additional benefits. Accordingly, other embodiments are within the scope of the following claims.

What is claimed is:

1. An apparatus for processing food comprising:
a fuel source;
an oxidizer source;
an igniter positioned to ignite a mixture of fuel from the fuel source with oxidizer from the oxidizer source to produce a shock wave, and being so positioned to sequentially ignite sequential such mixtures to produce sequential such shock waves; and
a conveyor carrying items of said food to an operative position to be impacted by said shock waves.

2. The apparatus of claim 1 further comprising:
a vessel; and
an aqueous liquid in the vessel, the vessel being positioned so that the conveyor carries the items of food through an operative position in the vessel, in which operative position the items of food are immersed in the liquid for the impact.

3. The apparatus of claim 2 further comprising:
at least a second igniter positioned to sequentially ignite fuel and oxidizer to produce sequential second shock waves, the conveyor carrying the items of food through a second operative position in which the items of food are immersed in the liquid for impact of such second shock waves.

4. The apparatus of claim 1 further comprising:
a combustor tube, positioned to direct the shock waves through air between the combustor tube and an item of said food in an operative position in front of said combustor tube.

5. The apparatus of claim 1 wherein:
the fuel consists essentially of hydrogen; and
the oxidizer consists essentially of oxygen.

6. The apparatus of claim 1 further comprising means for expediting a deflagration to detonation transition.

7. The apparatus of claim 6 wherein the means comprises at least one of:
an array of orifice plates;
an element having a spiral surface; and
means for introducing a first fuel/oxidizer mixture and a second fuel/oxidizer mixture, different from the first in chemistry or proportion, the second mixture being more detonable than the first.

8. The apparatus of claim 6 wherein the means comprises at least:
means for introducing a first fuel/oxidizer mixture and a second fuel/oxidizer mixture, different from the first in chemistry or proportion, the oxidizer of the second mixture being more oxygen-rich than the oxidizer of the first mixture.

9. An apparatus for processing food comprising:
a vessel for containing the food; and
means for initially pressurizing the food to a pressure above an ambient pressure and subsequently decompressing the food from said pressure.

10. The apparatus of claim 9 wherein the means operates in the absence of adding heat.

11. The apparatus of claim 9 further comprising cooling means.

12. The apparatus of claim 9 wherein:
the means comprises a gas mixture that reacts to decrease in molar amount from an initial condition to a reacted condition.

13. The apparatus of claim 9 wherein:
the means further comprises heat transfer means for cooling reaction products of the gas mixture.

14. The apparatus of claim 9 wherein:
the means comprises a piston, movable from an initial position to a second position to decrease pressure within the vessel.

15. A method for processing food comprising, for a given item of food, a plurality of times:
mixing a fuel and an oxidizer;
detonating the mixed fuel and oxidizer to produce a shock wave; and
impinging the shock wave upon said given item.

16. The method of claim 10 wherein shock waves are impinged upon said given item at a frequency of between one and ten waves per second and wherein at least five of said waves are impinged on said given item of food.

17. The method of claim 15 further comprising:
immersing the item in liquid, said impinging comprising passing said wave through said liquid.

18. The method of claim 15 performed repeatedly on a series of items of said food and wherein the mixing occurs in a combustor apparatus and the method comprises sequentially bringing the items of food to an operative position relative to said combustor.

19. A method for processing food comprising, for a given item of food, a plurality of times:
inserting the item in a volume of a vessel;
initially pressurizing the item to a pressure above an ambient pressure by compressing the volume; and
subsequently depressurizing the item from said pressure by decompressing the volume.

20. The method of claim 19 wherein:
the depressurizing is essentially more rapid than the pressurizing; and
the depressurizing is to a second pressure no less than the ambient pressure.
